(19) United States
(12) Patent Application Publication
(10) Pub. No.: US 2006/0076117 A1
(43) Pub. Date: Apr. 13, 2006

(54) Latex paper sizing composition

(76) Inventors: Delos E. Boardman, Marietta, GA (US); Terrence Edward Cotter, Kennesaw, GA (US); Vaughn L. Irwin, Mableton, GA (US)

Correspondence Address: KING & SPALDING LLP, 191 PEACHTREE STREET, N.E., 45TH FLOOR, ATLANTA, GA, 30303-1763, US

(21) Appl. No.: 11/274,816

(22) Filed: Nov. 14, 2005

Related U.S. Application Data
(63) Continuation of application No. 10/266,992, filed on Oct. 7, 2002, now abandoned.

(51) Int. Cl. D21H 21/16; C08B 30/12

(52) U.S. Cl. 162/135; 162/158; 162/175; 127/32

(57) ABSTRACT

Methods of sizing paper using a latex as a surface sizing agent are described, in which the latex is defined by acid number or particle size. Further described are methods of improving toner adhesion of papers that are surface sized with alkenylsuccinic anhydrides by employing latexes that have a glass transition temperature of from about 25 to about 65. Still further described are low shear methods of dispersing alkenylsuccinic anhydrides in sizing compositions using latexes as dispersing aids.

### RELATED APPLICATIONS

This application claims priority to U.S. Ser. No. 10/266,992, filed Oct. 7, 2002 (pending), and PCT/US03/031469, filed Oct. 6, 2003 (pending).

### FIELD OF THE INVENTION

This invention relates to latexes for sizing paper in surface sizing processes, and to the use of latexes to improve the performance of alkenylsuccinic anhydrides when used as internal and surface sizing agents.

### BACKGROUND OF THE INVENTION

Fine papers produced for use in office printers and high speed photocopiers must meet demanding physical and aesthetic criteria. The paper must have a good appearance and feel, and at the same time it must be durable and provide a receptive surface for receiving ink from such printers and copiers. The process by which the paper is sized during production can have a tremendous impact on the performance of the paper. Paper sizing typically is accomplished in one of two methods: (1) “internal sizing” or “wet end” sizing accomplished by mixing the sizing composition with a pulp slurry before sheet formation, and (2) “surface sizing” which is accomplished by adding sizing agents to a surface of a paper sheet that has been formed and at least partially dried.

Sizing agents are typically categorized either as reactive sizing agents or non-reactive sizing agents, depending on whether they form covalent bonds by reaction with the hydroxyl groups in cellulose. Non-reactive sizing agents that are commonly applied in surface sizing operations include starch and other polymeric sizes such as copolymers of styrene and vinyl monomers. Reactive sizing agents that are commonly applied in internal sizing processes include alkenylsuccinic anhydrides, alkyl ketene dimers, and rosin.

Varnell, in U.S. Pat. No. 6,051,107, discloses a process for surface sizing paper using size compositions that contain polymer latexes. The latexes have a glass transition temperature of −15° C. to 50° C., an acid number of 30 to 100, and an average particle size of 50 to 200 nanometers, preferably 80 to 150 nanometers. The patent does not disclose the concentrations of surfactant used in the production of these latexes. The examples in the patent disclose various commercially available latexes that are at least 100 nanometers in size. The patent indicates that the paper is preferably internally sized with one of various known internal sizing agents, and that the latex is preferably admixed with a starch or starch derivative before being applied to the surface of the paper.

Cenisio et. al. in U.S. Pat. No. 6,162,328, discloses a process for surface sizing paper by applying a surface sizing composition comprising starch, a non-reactive sizing agent, and a reactive sizing agent. Useful reactive sizing agents identified in the patent include ketene dimers and multimers, alkenylsuccinic anhydrides, organic epoxides, acyl halides, fatty acid anhydrides and organic isocyanates. The patent identifies two groups of non-reactive sizes that are used in the process: (1) those that are insoluble in water at pH less than about 6, and soluble at a pH above 6, and (2) those insoluble in water at pH's greater than about 6 and preferably having a primary glass transition temperature (T_{G}) of less than about 100° C.

Alkenylsuccinic anhydrides (sometimes hereinafter denoted “ASA”) are widely used paper sizing agents. However, they do not disperse well and typically require significant make-down conditions in a high energy mixer before being converted into aqueous emulsions that can be applied to paper, which increases the capital and operating costs of the system. In addition, make-down emulsification must typically be performed in the presence of a surfactant which is detrimental to the ultimate sizing performance. Indeed, an alkenylsuccinic anhydride sold by Bayer Chemicals, sold under the trade name Baysize I, is sold with surfactant already present to aid in this mixing. Alkenylsuccinic anyhdrides are generally not used in surface sizing operations because they interfere with toner fusion onto the paper.

EP 0 644 205 of Brinkley et al. discloses a method of producing nanolatexes that are less than 100 nanometers in size in reduced-surfactant environments. The document proposes numerous uses for the nanolatexes, including wood preservatives, polymer and metal coatings, water proofing textile sizes, inks, and paper making. EP 0 659 929 of Brinkley discloses similarly sized nanolatexes specifically designed for textile sizing operations.

It is an object of the invention to provide novel non-reactive sizes giving improved sizing performance in paper surface sizing processes.

It is another object of the invention to provide novel latexes in the nanoparticle size range exhibiting improved sizing performance.

Another object of the present invention is to improve the sizing performance of fine papers in terms of water absorbance and ink penetration.

Yet another object of the present invention is to provide improved processes for internal and surface sizing of paper by reducing the amount of surfactant present in chemical sizing agents.

Still another object of the invention is to improve the adhesion of toner that is applied to paper that has been surface sized by the addition of alkenylsuccinic anyhdride to the surface of the paper.

### SUMMARY OF THE INVENTION

It has surprisingly been discovered that latexes having a low acid number exhibit improved sizing performance when applied to paper in surface sizing operations. In particular, it has surprisingly been discovered that latexes that have an acid number below 30, when applied to paper in a surface sizing operation, improve the performance of the paper by decreasing the water absorption of the paper, and by decreasing the penetration of ink into the paper. Thus, in one embodiment the invention provides a method of making paper comprising (a) providing an aqueous pulp suspension; (b) sheeting and drying the aqueous suspension to obtain paper; (c) contacting the paper with a size composition comprising a latex having an acid number less than 30; and (d) drying the paper to obtain sized paper.

It has further been discovered that the performance of latexes as surface sizing agents can be improved by reducing the size of the latex to below about 100 nanometers. The improved performance can be seen especially when the latex is prepared in a low-surfactant environment, that minimizes the quantity of surfactant that is introduced to the surface sizing composition. Thus, in another embodiment the invention provides a method of making paper comprising: (a) providing an aqueous pulp suspension; (b) sheeting and drying the aqueous suspension to obtain paper; (c) contacting the paper with a size composition comprising a dispersion of latex particles having an average particle size of from about 20 to about 100 nanometers, and a surfactant contribution from the latex of less than about 20% (w/w) based on the weight of the latex; and (d) drying the paper to obtain sized paper.

It has further been discovered that when a latex and alkenylsuccinic anhydride are both applied as surface sizing agents, the toner fusion of the resulting paper can be improved by employing a latex having a glass transition temperature within a preferred range. Thus, in still another embodiment the invention provides a method of making paper sized with an alkenylsuccinic anhydride having improved toner fusion comprising: (a) providing an aqueous pulp suspension; (b) sheeting and drying the aqueous suspension to obtain paper; (c) contacting the paper with a surface size composition comprising an alkenylsuccinic anhydride and a latex having a glass transition temperature of from about 25 to about 65° C.; and (d) drying the paper to obtain sized paper.

It has further been discovered that the required make-down of alkenylsuccinic anhydrides into an aqueous emulsion can be reduced by dispersing the alkenylsuccinic anhydrides in the presence of a latex. The reduced make-down requirements decrease the amount of shear that must be applied to the alkenylsuccinic anyhdrides to effect the make-down, allow the alkenylsuccinic anhydrides to be mixed in a sizing composition in an in-line mixer, and also reduce the amount of surfactant that must be added to the alkenylsuccinic anyhdrides to accomplish the make-down. Latexes can thus improve the process economics of any process in which an alkenylsuccinic anhydride is applied as a sizing agent, as well as the performance of the alkenylsuccinic anhydride due to the reduced concentration of surfactant in the alkenylsuccinic anhydride, whether the alkenylsuccinic anhydride is applied as a surface sizing agent or an internal sizing agent. Thus, in another embodiment the invention provides a method of making paper sized with an alkenylsuccinic anhydride comprising: (a) providing an aqueous pulp suspension; (b) sheeting and drying the aqueous suspension to obtain paper; (c) contacting the aqueous suspension or paper with an internal or surface size composition comprising an alkenylsuccinic anhydride and a latex; and (d) drying the paper to obtain sized paper, wherein (i) the alkenylsuccinic anhydride and latex are mixed in a low shear process, (ii) the alkenylsuccinic anhydride and latex are mixed in an in-line mixer, or (iii) the surfactant contribution from the latex in the surface size composition is less than 20% (w/w).

In another embodiment the invention provides a method of making a size composition comprising (a) providing an aqueous latex dispersion, and (b) mixing ASA with the aqueous latex dispersion in an in-line mixer and/or under low shear.

Further embodiments relate to surface sizing compositions, and to paper coated with such surface sizing compositions, in which the surface sizing composition comprises:
a) starch; and
b) a latex selected from:
   i) a latex having an acid number less than 30;
   ii) a latex having an average particle size of from about 20 to about 100 nanometers, and a surfactant contribution from the latex of less than about 20% (w/w) based on the weight of the latex;
   iii) a latex having a glass transition temperature of from about 25 to about 65° C., wherein the surface sizing composition further comprises an alkenylsuccinic anhydride; or
   iv) a latex, wherein the surface sizing composition further comprises an alkenylsuccinic anhydride and the alkenylsuccinic anhydride and latex are mixed in an in-line mixer or a low shear process.

The polymer latexes may be made from a variety of monomers and combinations of monomers known to form latexes through emulsion polymerization, but preferably comprise a blend of residues from the following three monomers: (1) styrene, (2) an alkyl acrylate or methacrylate, and (3) an ethylenically unsaturated carboxylic acid.

### BRIEF DESCRIPTION OF THE FIGURES

FIG. 1 is a graphical plot of data from the surface sizing experiments of example 4 illustrating the effect of nanolatex particle size on HST.

FIG. 2 is a graphical plot of data from the surface sizing experiments of example 4 illustrating the effect of nanolatex particle size on Cobb absorption.

FIG. 3 is a graphical plot of data from the surface sizing experiments of example 5 illustrating the effect of nanolatex acid number on HST.

FIG. 4 is a graphical plot of data from the surface sizing experiments of example 5 illustrating the effect of nanolatex acid number on Cobb absorption.

### DEFINITIONS

The term nanolatex, when used in this document, means a dispersion or emulsion of latex particles having an average particle size of from about 10 nanometers to about 100 nanometers. The term “latex” refers to an aqueous emulsion of natural or synthetic rubber or plastic capable of forming a film when dried on a surface, having properties that are characteristic of colloidal dispersions obtained through emulsion polymerization such as particle sphericity and Gaussian size distributions. Latexes useful in the present invention preferably have a particle size of less than about 1000 nanometers, more preferably less than about 500 nanometers, still more preferably less than about 200 nanometers, and most preferably are within the nanolatex size range.

A “surface size” or “surface sizing agent” means a size or agent that provides, upon addition to paper at a size press in combination with a starch typically used as a surface size, at the levels disclosed herein, an increase of sizing as measured by the Hercules Sizing Test (HST) method over the same paper treated with only starch at the same level.

The term alkyl, as used herein, unless otherwise specified, refers to a saturated straight, branched, or cyclic, primary, secondary, or tertiary hydrocarbon, typically of C₁ to C₁₂, and specifically includes methyl, ethyl, propyl, isopropyl, butyl, isobutyl, t-butyl, pentyl, cyclopentyl, isopentyl, neopentyl, hexyl, isohexyl, cyclohexyl, cyclohexylmethyl, 3-methylpentyl, 2,2-dimethylbutyl, and 2,3-dimethylbutyl. The alkyl group can be optionally substituted with one or more moieties selected from the group consisting of hydroxyl, carboxy, carboxamido, carboalkoxy, acyl, amino, alkylamino, arylamino, alkoxy, aryloxy, nitro, cyano, sulfonic acid, sulfate, phophonic acid, phosphate, or phosphonate, either unprotected, or protected as necessary, as known to those skilled in the art, for example, as taught in Greene, et al., “Protective Groups in Organic Synthesis,” John Wiley and Sons, Second Edition, 1991, hereby incorporated by reference.

The term lower alkyl, as used herein, and unless otherwise specified, refers to a C₁ to C₅ saturated straight, branched, or if appropriate, a cyclic (for example, cyclopropyl) alkyl group. The lower alkyl group can be optionally substituted in the same manner as described above for the alkyl group.

The term “alkenyl,” as referred to herein, and unless otherwise specified, refers to a straight, branched, or cyclic hydrocarbon of C₂ to C₁₂ with at least one double bond. The alkenyl group can be optionally substituted in the same manner as described above for the alkyl group.

The term aryl, as used herein, and unless otherwise specified, refers to phenyl, biphenyl, or naphthyl, and preferably phenyl. The aryl group can be optionally substituted with one or more moieties selected from the group consisting of hydroxyl, acyl, amino, halo, carboxy, carboxamido, carboalkoxy, alkylamino, alkoxy, aryloxy, nitro, cyano, sulfonic acid, sulfate, phosphonic acid, phosphate, or phosphonate, either unprotected, or protected as necessary, as known to those skilled in the art, for example, as taught in Greene, et al., “Protective Groups in Organic Synthesis,” John Wiley and Sons, Second Edition, 1991.

The term aralkenyl, as used herein, and unless otherwise specified, refers to an aryl group as defined above linked to the molecule through an alkyenl group as defined above. The aralkyl group can be optionally substituted with one or more moieties selected from the group consisting of hydroxyl, carboxy, carboxamido, carboalkoxy, acyl, amino, halo, alkylamino, alkoxy, aryloxy, nitro, cyano, sulfonic acid, sulfate, phosphonic acid, phosphate, or phosphonate, either unprotected, or protected as necessary, as known to those skilled in the art, for example, as taught in Greene, et al., “Protective Groups in Organic Synthesis,” John Wiley and Sons, Second Edition, 1991.

“Particle size” means the volume average median size of particles in an emulsion or dispersion as measured by photon correlation spectroscopy. The standard deviation of the particle size is preferably within about 50%, 40%, or 30%.

### DETAILED DISCUSSION

In one aspect the invention provides latexes and their use as surface sizing agents. They are applied to paper in a paper making process that comprises: (a) providing an aqueous pulp suspension; (b) sheeting and drying the aqueous suspension to obtain paper; (c) contacting the paper with a surface size composition that comprises a latex of the present invention; and (d) drying the paper to obtain sized paper. In preferred embodiments the latex of the present invention is defined by one or more of the following three criteria, in any combination: (1) acid number, (2) glass transition temperature, and/or (3) particle size and surfactant concentration.

In one particular embodiment the surface sizing composition comprises a latex having an acid number less than 30. In various embodiments, the acid number can be from 0 to about 25, 0 to about 20, to about 10, 0 to about 7, 0 to about 5, or 0 to about 3.

While the pH of the aqueous pulp suspension is important to the ultimate performance of the sizing composition in most paper making operations, a distinct advantage of the present invention is that the sizing process can be practiced over a wide range of pH systems. This is a consequence of the low acid number of the latexes and their reduced dependence on pH for effectiveness. Thus, the invention can be practiced in systems in which the pH ranges from about 3 to about 9, from about 4 to about 5, from about 5 to about 6, from about 6 to about 7, and from about 7 to about 8, or any combination thereof.

In another particular embodiment, which has been found especially useful for improving toner adhesion, the latex has a glass transition temperature of from about 25° C. to about 65° C. This embodiment is preferred when surface sizing compositions that also include an ASA are employed in the paper making process. In various embodiments the glass transition temperature of the latexes of the present invention is from about 25 to about 65° C., from about 30 to about 60° C., from about 35 to about 55° C., from about 40 to about 50° C., or about 45° C.

In another particular embodiment the latex has an average particle size of from about 20 to about 100 nanometers. In other embodiments the average particle size of the latexes is from about 25 to about 90 nanometers, from about 30 to about 90 nanometers, from about 30 to about 80 nanometers, from about 40 to about 80 nanometers, or from about 40 to about 70 nanometers.

These particle sizes are preferably present in the presence of minimal surfactant concentrations. In this context, the surfactant concentration refers to the quantity of surfactant that is employed in the emulsion polymerization process to manufacture the latex, relative to the quantity of latex produced in the polymerization step. The latex is preferably prepared in a solution comprising from about 1 to about 20% (w/w) surfactant, from about 1 to about 12% (w/w), from about 1 to about 8% (w/w) surfactant, from about 1 to about 5% (w/w) surfactant, or from about 1 to about 3% (w/w) surfactant, based upon the weight of latex produced in the polymerization step. The sizing compositions of the present invention are frequently described as having a “surfactant contribution from the latex.” This means that the latex is emulsion polymerized in the presence of the recited quantity or proportion of surfactant. Exemplary processes for producing nanolatexes in the presence of low concentrations of surfactant are disclosed in the examples herein below, and in EP 0 644 205 of Brinkley et al., the disclosure of which is hereby incorporated by reference.

It has further been discovered that the required make-down of alkenylsuccinic anhydrides into aqueous emulsions can be reduced by dispersing the alkenylsuccinic anhydrides in the presence of a latex. The reduced make-down requirements decrease the amount of energy or shear that must be applied to the ASAs to effect the make-down, and also reduce the amount of surfactant that must be added to the ASAs, whether the ASA is applied as a surface sizing agent or an internal sizing agent. A typical high shear mixing system for a pure ASA would employ a rotor-stator type mixing head operating in either batch or in-line style mixing modes at radial tip speeds in excess of 4,000 feet per minute which accordingly have very high horsepower demands dependent on the commercial throughput requirements. Alternatively, a pressurized plate homogenizer may be used when high mixing shear is needed. In the presence of a latex, the make down of ASA can be performed in a low-shear environment such as an in-line mixer, and/or in the presence of low surfactant concentrations. Exemplary in-line mixers include static mixers, in-line homogenizers, and the like which can be fed with a standard centrifugal pump.

For purposes of this document, the term “low shear” means the amount of shear imparted by an impeller-type mixer operating at a radial tip speed of less than about 2,000 feet per minute, 1,500 feet per minute, or 1,000 feet per minute, and greater then about 250 or 500 feet per minute. Low shear mixing according to the present invention is typically performed using an impeller-type mixer at from about 500 to about 1,000 feet per minute.

Thus in another embodiment the invention provides a method of making paper sized with an alkenylsuccinic anhydride comprising: (a) providing an aqueous pulp suspension; (b) sheeting and drying the aqueous suspension to obtain paper; (c) contacting the aqueous suspension or paper with an internal or surface size composition comprising an alkenylsuccinic anhydride and a latex; and (d) drying the paper to obtain sized paper, wherein (i) the alkenylsuccinic ahnydride and latex are mixed in a low shear mixer, (ii) the alkenylsuccinic ahnydride and latex are mixed in an in-line mixer, and/or (iii) the surfactant contribution from the latex is less than about 20% (w/w) based on the weight of the latex.

In yet another embodiment the invention provides a method of making a size composition comprising (a) providing an aqueous latex dispersion, and (b) mixing ASA with the aqueous latex dispersion in an in-line mixer. In another embodiment the invention provides a method of making a size composition comprising (a) providing an aqueous latex dispersion, and (b) mixing ASA with the aqueous latex dispersion under low shear, thereby eliminating the need for using a high shear rotor-stator mixer. In still another embodiment the invention provides a method of making a size composition comprising (a) providing an aqueous latex dispersion, and (b) mixing ASA with the aqueous latex, wherein the surfactant contribution from the latex is less than about 20% (w/w) based on the weight of the latex. In a preferred embodiment, the aqueous latex dispersion comprises starch, and is produced by mixing the latex dispersion with a starch solution or dispersion, preferably in a continuous mixing process that precedes the ASA mixing process.

When the latex is used as a dispersing aid as discussed above, it generally is not limited by the technical specifications that define the latex in other embodiments of the invention such as acid number or particle size. Indeed, the only preferred requirements are that the latex have an average particle size of from about 10 nanometers to about 100 nanometers, or from about 30 to about 80 nanometers. Nevertheless, it will be understood that the latex can further be characterized by any combination of (1) acid number, (2) glass transition temperature, (3) particle size, or (4) surfactant concentration, as discussed above.

The latexes of the present invention may be made from a variety of monomers and combinations of monomers known to form latexes through emulsion polymerization, but preferably comprise copolymers (ternary, or higher) of styrene or substituted styrenes with vinyl monomers and ethylenically unsaturated carboxylic acids. Examples of such vinyl monomers include, but are not restricted to maleic anhydride, acrylic acid or its alkyl esters, methacrylic acid or its alkyl esters, itaconic acid, divinyl benzene, acrylamide, acrylonitrile, cyclopentadiene and mixtures thereof. Examples of ethylenically unsaturated carboxylic acids include acrylic acid, methacrylic acid, maleic acid or anhydride, fumaric acid, itaconic acid and mixtures thereof. Latexes also include polyurethanes and copolymers of ethylene with comonomers such as vinyl acetate, acrylic acid and methacrylic acid.

The latexes of the present invention preferably comprise a ternary blend of monomers selected from (1) styrene, (2) alkyl acrylate or methacrylate, and (3) ethylenically unsaturated carboxylic acids. The alkyl group of the alkyl acrylate or methacrylate preferably comprises from 1 to 12 carbon atoms, more preferably from about 1 to about 8 carbon atoms. Preferred alkyl acrylates or methacrylates are methyl methacrylate, ethyl acrylate, ethyl methacrylate, propyl acrylate, butyl acrylate, butyl methacrylate, 2-ethylhexyl acrylate, 2-ethylhexyl methacrylate, lauryl acrylate, lauryl methacrylate, and mixtures thereof.

Preferred ethylenically unsaturated carboxylic acids are alpha, beta unsaturated carboxylic acids having a carbon number of from about 3 to about 12, more preferably from about 3 to about 6 carbons. Exemplary ethylenically unsaturated carboxylic acids include acrylic acid, methacrylic acid, maleic acid, fumaric acid and itatonic acid. Preferred acids are acrylic acid and methacrylic acid, with methacrylic acid being most preferred.

In various preferred embodiments the latex comprises:

a) From about 65 to about 45 monomeric parts alkyl acrylate or methacrylate, from about 0 to about 10 monomeric parts ethylenically unsaturated carboxylic acid, and from about 40 to about 45 monomeric parts styrene;

b) From about 60 to about 50 monomeric parts alkyl acrylate or methacrylate, and from about 0 to about 7 monomeric parts ethylenically unsaturated carboxylic acid, and from about 40 to about 45 monomeric parts styrene;

c) From about 58 to about 52 monomeric parts alkyl acrylate or methacrylate, and from about 0 to about 5 monomeric parts ethylenically unsaturated carboxylic acid, and from about 40 to about 45 monomeric parts styrene; or

d) From about 57 to about 54 monomeric parts alkyl acrylate or methacrylate, and from about 0 to about 3 monomeric parts ethylenically unsaturated carboxylic acid, and from about 41 to about 44 monomeric parts styrene.

In each of the foregoing embodiments, the monomeric parts of ethylenically unsaturated carboxylic acid is preferably greater than about 0.5, 1, or 2.

Alkenylsuccinic anhydrides, or “ASAs” useful in the invention are composed of unsaturated hydrocarbon chains containing pendant succinic anhydride groups. They are usually made in a two-step process starting with an alpha olefin. The olefin is first isomerized by randomly moving the double bond from the alpha position. In the second step the isomerized olefin is reacted with maleic anhydride. Typical olefins used for the reaction with maleic anhydride include alkenyl, cycloalkenyl and aralkenyl compounds containing from about 8 to about 22 carbon atoms. Specific examples are isooctadecenylsuccinic anhydride, n-octadecenylsuccinic anhydride, n-hexadecenylsuccinic anhydride, n-dodecylsuccinic anhydride, i-dodecenylsuccinic anhydride, n-decenylsuccinic anhydride and n-octenylsuccinic anhydride.

Alkenylsuccinic anhydrides are disclosed in U.S. Pat. No. 4,040,900, which is incorporated herein by reference in its entirety, and by C. E. Farley and R. B. Wasser in The Sizing of Paper, Second Edition, edited by W. F. Reynolds, Tappi Press, 1989, pages 51-62. A variety of alkenylsuccinic anhydrides are commercially available from Kemira OY under the trade name HYDRORES AS 1000, from Bayer Chemicals under the trade name BAYSIZE or ACCOSIZE, and from Nalco as NALSIZE. In addition, Albemarle Corporation provides ASA to relabelers for sale under a variety of trade names. Alkenylsuccinic anhydrides for use in the invention are preferably liquid at 25° C. More preferably they are liquid at 20° C.

When applied as surface sizing agents, the latexes of the present invention typically will be applied along with starch or a starch derivative in an aqueous solution or dispersion. Suitable starches include oxidized, ethylated, cationic and pearl starches.

The aqueous size composition preferably contains from about 1 to about 20 wt. % starch, more preferably from about 2 to about 15 wt. % starch, and even more preferably from about 3 to about 8 wt. % starch. The latex is preferably present in an amount of from about 0.05 to about 2.5 wt. %, and more preferably from about 0.10 to about 2.0 wt. % (based on dry latex to dry starch). When ASA is present, it is preferably present in an amount of from about 0.01 to about 5.0 wt. %, and more preferably from about 0.02 to about 4.0 wt. % (based on dry starch). The pH of the composition is preferably from about 6 to about 9, preferably above about 7. Small amounts of other additives may be present as well, such as optical brighteners and defoamers. In a preferred embodiment EDTA is present in the sizing composition to improve the physical pumping stability of the latex, in an amount of from about 2 to about 10 wt. % (based upon the weight of the latex particles).

The amount of aqueous size composition applied to the paper is preferably sufficient to yield paper coated by from about 0.02 wt. % to about 0.8 wt. % latex, on a dry basis based on the weight of the dry sheet of paper, more preferably from about 0.03 wt. % to about 0.5 wt. %, and most preferably from about 0.05 wt. % to about 0.1 wt. %. The amount of starch applied to the sheet is generally from about 0.5 to about 8 wt. %, more preferably from about 1 to about 6 wt. %, and most preferably from about 2 to about 5 wt. %, on a dry basis based on the weight of the dry sheet of paper. When ASA is applied either as an internal or surface sizing agent, it is preferably present in an amount of from about 0.01 to about 1.0 wt. %, more preferably from about 0.02 to about 0.5 wt. %, and most preferably from about 0.03 to about 0.3 wt. %, on a dry basis based on the weight of the dry sheet of paper.

The aqueous pulp suspension of step (a) of the process is obtained by means well known in the art, such as known mechanical, chemical and semichemical, etc., pulping processes. Normally, after the mechanical grinding and/or chemical pulping step, the pulp is washed to remove residual pulping chemicals and solubilized wood components. Either bleached or unbleached pulp fiber may be utilized in the process of this invention. Recycled pulp fibers are also suitable for use.

The sheeting and drying of the pulp suspension is carried out by methods well known in the art. A variety of materials can be added to the aqueous pulp suspension before it is converted into paper, including wet strength resins, internal sizes, dry strength resins, alum, fillers, pigments and dyes. In a preferred embodiment the sheet is internally sized with any conventional internal sizing agent before being sheeted and dried. Exemplary internal sizing agents include rosin sizes, ketene dimers and multimers, and alkenylsuccinic anhydrides. In a preferred embodiment the internal size is cured before surface sizing agents are applied to the paper. ASAs are preferred because of their high curing ability.

Methods and materials utilized for internal sizing are discussed by E. Strazdins in The Sizing of Paper, Second Edition, edited by W. F. Reynolds, Tappi Press, 1989, and C. E. Farley and R. B. Wasser in The Sizing of Paper, Second Edition, edited by W. F. Reynolds, Tappi Press, 1989.

### EXAMPLES

Standard Methods

Cobb is a measure of water absorption and is actually the quantity of water absorbed by one square meter of the treated paper. Lower Cobb values are better since they indicate less water absorption. This test method is described in TAPPI Standard T 441.

The Hercules Size Test, an art-recognized test for measuring sizing performance, is described in Pulp and Paper Chemistry and Chemical Technology, J. P. Casey, Ed., Vol. 3, p. 1553-1554 (1981) and in TAPPI Standard T530. The Hercules Size Test determines the degree of water sizing obtained in paper by measuring the change in reflectance of the paper's surface as an aqueous solution of dye penetrates from the opposite surface side. The aqueous dye solution, e.g., naphthol green dye in 1% formic acid, is contained in a ring on the top surface of the paper, and the change in reflectance is measured photoelectrically from the bottom surface.

For all of the examples below, the paper used for sizing was prepared in advance, stored, and then treated on a laboratory puddle size press with the materials described. In all cases the base paper had no treatment applied at the size press during its manufacture. The application of materials at the size press consisted of dissolving starch in water by stirring and heating to about 95° C. for at least 20 minutes or alternating heating in a sealed container in a microwave oven then stirring on a magnetic stirrer until homogeneous. The starch solution was then kept at 60° C. until used, usually within one hour. The sizing materials were mixed with the starch for a few minutes and then added to the nip of two rollers on the puddle size press.

The untreated paper was fed through the rollers twice to apply the solution in the nip to the paper. The amount of solution applied to the paper by a specific starch solution under specific conditions was determined and used to set the level of additives in the starch solution to give the desired level of paper treatment.

Immediately following the application of the size press composition, the papers were dried on a drum dryer heated at 120-130° C. The papers were then conditioned and tested.

### Example 1

In a glass polymerization reactor equipped with heating/cooling source and controls, stirrer, metering device for liquid substances, input opening for N₂ sparge addition, and reflux condenser, 16.3 gm of sodium laurel sulfate (30% solids) is placed in 443.3 gm demineralized water. This mixture, stirred and under a constant N₂ sparge, is heated to 182° F. and the temperature allowed to stabilize at this set point. A solution of 0.0333 gm ammonium persulfate in 36.09 gm demineralized water is added to the reaction media, which is held 10 minutes while the temperature re-stabilizes at 182° F. Starting simultaneously, two solutions are dosed into this preparation over a period of 2.25 hours. Solution 1 consists of 0.100 gm ammonium persulfate dissolved in 41.9 gm demineralized water. Solution 2 consists of 84.1 gm styrene, 1.39 gm n-dodecyl mercaptan, 58.8 gm methyl methacrylate, 49.17 gm butyl acrylate, and 3.92 gm methacrylic acid. 1.0 hours after the start of these concurrent solutions being fed into the reaction zone, a third solution of 122.7 gm demineralized water is started to finish simultaneously with the other two additions. After termination of the dosages, stirring is continued at 182° F. for an additional 30 minutes. Cooling is applied to the reactor, and 32.84 gm demineralized water is added. When the reactor contents are at <75° F., sufficient ammonium hydroxide diluted with demineralized water is added to adjust the solution pH to 7.0-7.5. The final product is a microlatex with a solids content of ˜22.4%, acid value of ˜2.85, Tg of ˜45° C. (˜113° F.) and a particle size of ˜50 NM as measured by light scattering methods.

### Example 2

The method of example 1 was followed except that Feed Solution 2 contained 84.1 gm styrene, 1.38 gm n-dodecyl mercaptan, 53.69 gm methyl methacrylate, 54.28 gm butyl acrylate, and 3.93 gm methacrylic acid. The final product is a microlatex with a solids content of ˜22.4%, acid value of ˜2.85, Tg of ˜40° C. (˜104° F.) and a particle size of ˜50 NM as measured by light scattering methods.

### Example 3

The method of example 1 was followed except that Feed Solution 2 contained 84.1 gm styrene, 1.38 gm n-dodecyl mercaptan, 63.69 gm methyl methacrylate, 44.28 gm butyl acrylate, and 3.93 gm methacrylic acid. The final product is a microlatex with a solids content of ˜22.4%, acid value of ˜2.85, Tg of ˜50° C. (˜122° F.) and a particle size of ˜50 NM as measured by light scattering methods.

### Example 4

In this example the effect of nanolatex particle size on surface sizing performance was determined. A series of experiments was performed using a nanolatex produced according to the procedures set forth in examples 1-3. The nanolatex was applied to paper in the surface sizing process described above. The acid number of the nanolatexes was held constant at 2.9. Particle sizes ranging from 20 to 160 nanometers were applied at 1, 2, 4, and 8 wet pounds per ton (wherein a wet pound is the equivalent of about one fourth of a dry pound).

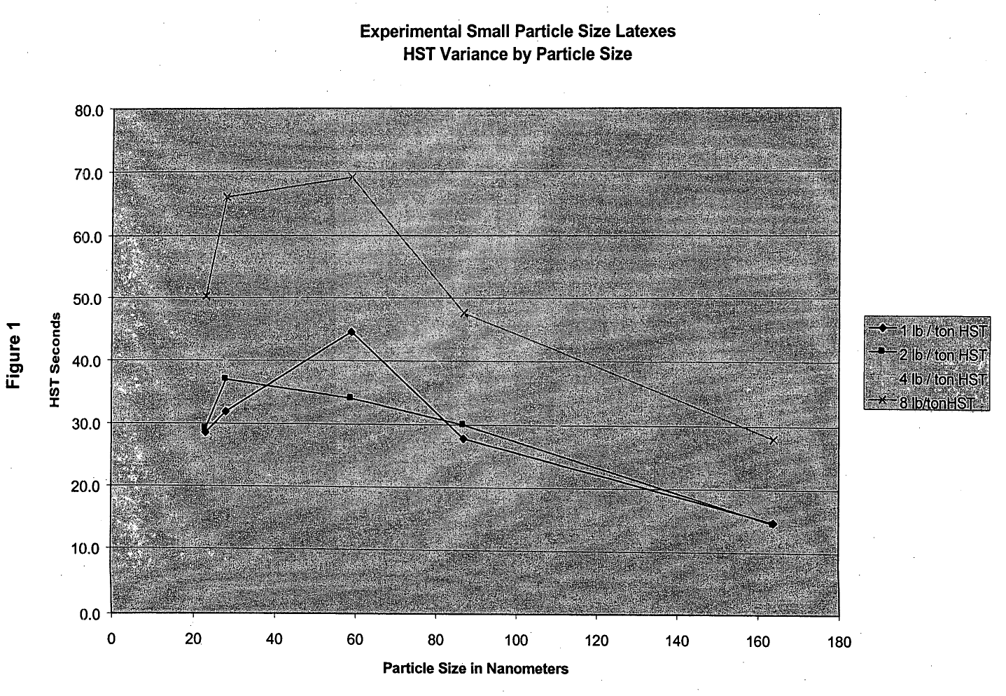

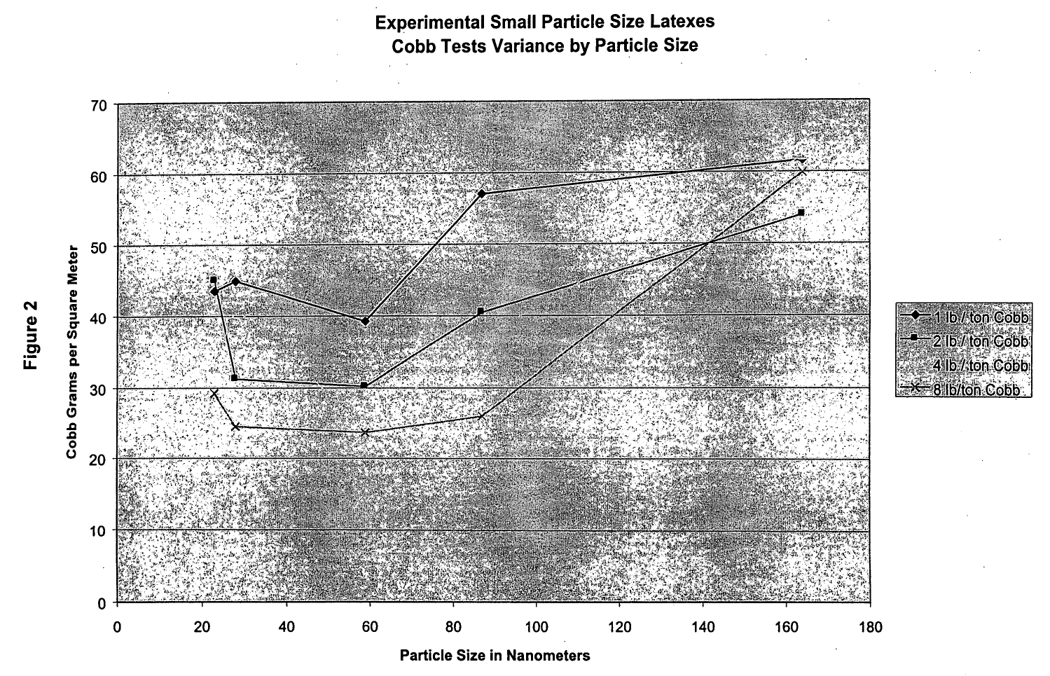

Sizing performance was evaluated according to HST and Cobb absorption test protocol. Experimental results are tabulated in Table 1. The effect of particle size on HST is plotted in FIG. 1. The effect of particle size on Cobb absorption is plotted in FIG. 2.

### Example 5

In this example the effect of nanolatex acid number on surface sizing performance was determined. A series of experiments was performed using a nanolatex produced according to the procedures set forth in examples 1-3. The nanolatex was applied to paper in the surface sizing process described above. The size of the nanolatexes varied from about 35 to about 60 nanometers. The acid number of the nanolatexes varied from about 0 to about 30. The particles were applied at 1, 2, 4, and 8 wet pounds per ton (wherein a wet pound is the equivalent of about one fourth of a dry pound).

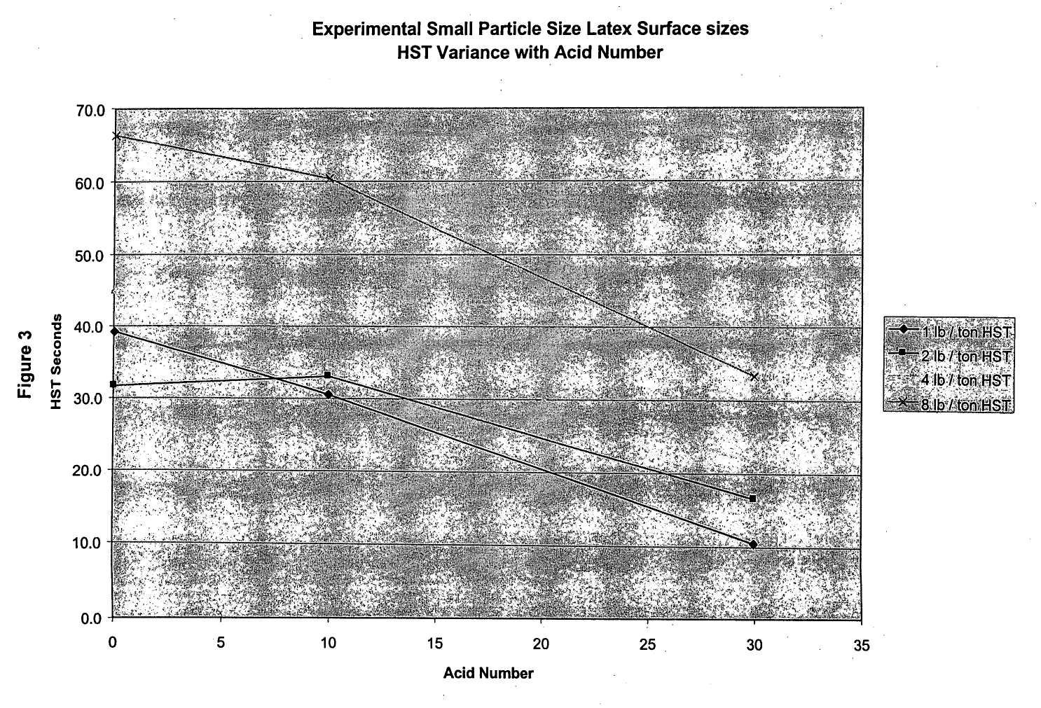

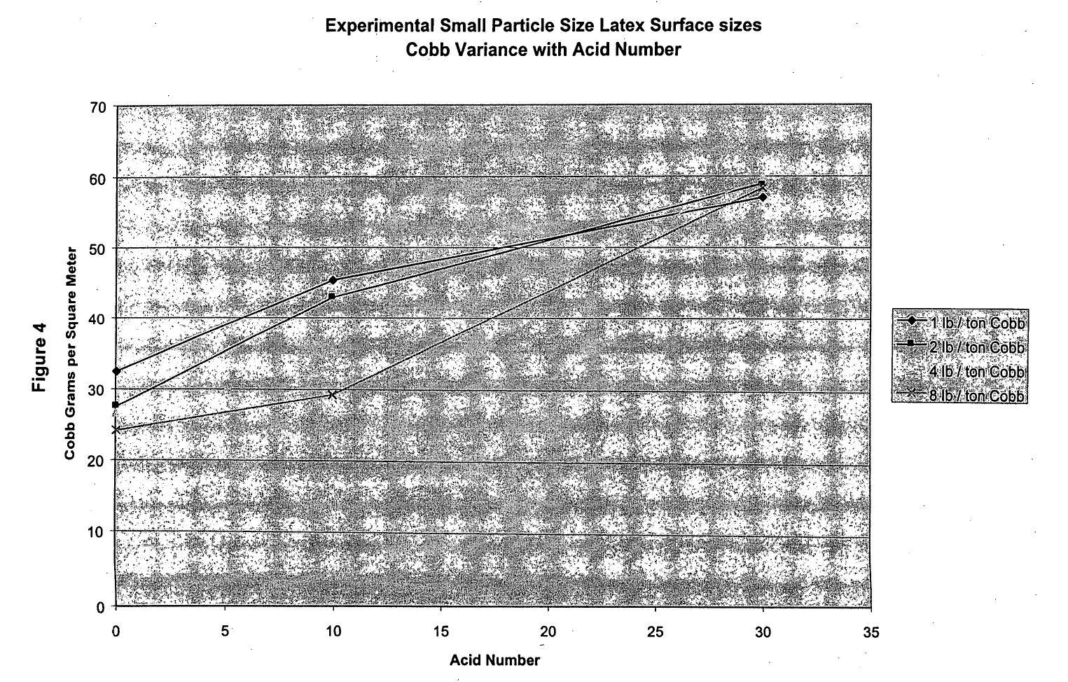

Sizing performance was evaluated according to HST and Cobb absorption test protocol. Experimental results are tabulated in Table 1. The effect of acid number on HST is plotted in FIG. 3. The effect of acid number on Cobb absorption is plotted in FIG. 4.

TABLE 1

| Particle | | 0.25 lb per ton | | | 0.5 lb per ton | | | 1 lb per ton | | 2 lb per ton | |
|---|---|---|---|---|---|---|---|---|---|---|---|
| Size (nm) | Acid # | Cobb60 | Cobb30 | HST | HST | Cobb ₄₅ | Cobb ₆₀ | HST | Cobb ₄₅ | HST | Cobb ₆₀ |
| Starch | | 61.36 | 41.59 | 21.1 | | | | | | | |
| 23 | 2.9 | 43.5 | 37.76 | 28.5 | 29.15 | 45.00 | 41.04 | 32.30 | 32.93 | 50.25 | 29.26 |
| 28 | 2.9 | 44.9 | 40.7 | 31.9 | 36.98 | 31.25 | 45.44 | 40.10 | 41.13 | 66.13 | 24.57 |
| 59 | 2.9 | 39.23 | 26.31 | 44.6 | 34.03 | 30.18 | 42.78 | 56.98 | 24.48 | 69.13 | 23.69 |
| 87 | 2.9 | 57.05 | 31.82 | 27.8 | 29.98 | 40.43 | 44.09 | 34.83 | 36.94 | 47.65 | 26.05 |
| 164 | 2.9 | 61.64 | 55.15 | 14.8 | 14.55 | 54.03 | 68.73 | 19.03 | 62.18 | 28.00 | 59.87 |
| 60 | 0.04 | 32.47 | 31.88 | 39.2 | 31.63 | 27.54 | 42.02 | 45.08 | 26.69 | 66.35 | 24.15 |
| 46 | 10 | 45.44 | 31.89 | 30.5 | 33.03 | 42.98 | 43.28 | 38.48 | 33.13 | 60.38 | 29.25 |
| 35 | 30 | 57.02 | 50.48 | 10.5 | 16.58 | 59.02 | 58.12 | 21.73 | 59.95 | 33.28 | 58.38 |

The present invention may be embodied in other specific forms without departing from the spirit or essential attributes thereof and accordingly reference should be made to the appended claims rather than the foregoing specifications as indicating the scope of the invention.

What is claimed is:

1) A method of making paper comprising:
a) providing an aqueous pulp suspension;
b) sheeting and drying the aqueous suspension to obtain paper;
c) contacting the paper with a size composition comprising a latex having an acid number less than 30; and
d) drying the paper to obtain sized paper.

2) The method of claim 1 wherein the latex has an acid number of less than 20.

3) The method of claim 1 wherein the latex has an acid number of less than 10.

4) The method of claim 1 wherein the latex has an acid number of less than 5.

5) The method of claim 1 wherein the latex particles have an average particle size of from about 30 to about 90 nanometers.

6) The method of claim 1 wherein the latex has a glass transition temperature of from about 35 to about 55° C.

7) The method of claim 1 wherein the surface size composition comprises an alkenylsuccinic anhydride and a latex mixed in a low shear process.

8) The method of claim 1 wherein the latex comprises monomeric residues of styrene, alkyl acrylate or methacrylate, and an ethylenically unsaturated carboxylic acid.

9) A method of making paper comprising:
a) providing an aqueous pulp suspension;
b) sheeting and drying the aqueous suspension to obtain paper;
c) contacting the paper with a size composition comprising a dispersion of latex particles having an average particle size of from about 20 to about 100 nanometers, and a surfactant contribution from the latex of less than about 20% (w/w) based on the weight of the latex; and
d) drying the paper to obtain sized paper.

10) The method of claim 9 wherein the latex particles have an average particle size of from about 30 to about 90 nanometers.

11) The method of claim 9 wherein the latex particles have an average particle size of from about 40 to about 80 nanometers.

12) The method of claim 9 wherein the latex has an acid number of less than about 20.

13) The method of claim 9 wherein the latex has a glass transition temperature of from about 35 to about 55° C.

14) The method of claim 9 wherein the surface size composition comprises an alkenylsuccinic anhydride and a latex mixed in a low shear process.

15) The method of claim 9 wherein the latex comprises monomeric residues of styrene, alkyl acrylate or methacrylate, and an ethylenically unsaturated carboxylic acid.

16) A method of making paper sized with an alkenylsuccinic anhydride having improved toner fusion comprising:
a) providing an aqueous pulp suspension;
b) sheeting and drying the aqueous suspension to obtain paper;
c) contacting the paper with a surface size composition comprising an alkenylsuccinic anhydride and a latex having a glass transition temperature of from about 25 to about 65° C.; and
d) drying the paper to obtain sized paper.

17) The method of claim 16 wherein the latex has a glass transition temperature of from about 35 to about 55° C.

18) The method of claim 16 wherein the latex has a glass transition temperature of from about 40 to about 50° C.

19) The method of claim 16 wherein the latex has an acid number of less than about 20.

20) The method of claim 16 wherein the latex particles have an average particle size of from about 30 to about 90 nanometers.

21) The method of claim 16 wherein the alkenylsuccinic anhydride and latex are mixed in a low shear process.

22) The method of claim 16 wherein the latex comprises monomeric residues of styrene, alkyl acrylate or methacrylate, and an ethylenically unsaturated carboxylic acid.

23) A method of making paper sized with an alkenylsuccinic anhydride comprising:
a) providing an aqueous pulp suspension;
b) sheeting and drying the aqueous suspension to obtain paper;
c) contacting the aqueous suspension or paper with an internal or surface size composition comprising an alkenylsuccinic anhydride and a latex; and
d) drying the paper to obtain sized paper;
wherein (i) the alkenylsuccinic anhydride and latex are mixed in a low shear process, (ii) the alkenylsuccinic anhydride and latex are mixed in an in-line mixer, or (iii) the surfactant contribution from the latex in the surface size composition is less than 20% (w/w) based upon the weight of the latex.

24) The method of claim 23 Wherein the latex has a glass transition temperature of from about 35 to about 55° C.

25) The method of claim 23 wherein the latex has an acid number of less than about 20.

26) The method of claim 23 wherein the latex particles have an average particle size of from about 30 to about 90 nanometers.

27) The method of claim 23 wherein the latex comprises monomeric residues of styrene, alkyl acrylate or methacrylate, and an ethylenically unsaturated carboxylic acid.

28) A method of making a size composition comprising providing an aqueous latex dispersion and mixing ASA with the aqueous latex dispersion, wherein:
a) the ASA is mixed with the latex dispersion in an in-line mixer, or
b) the ASA is mixed with the latex dispersion under low shear; or
c) the surfactant contribution from the latex in the surface size composition is less than 20% (w/w) based upon the weight of the latex.

29) A surface sizing composition comprising:
a) starch; and
b) a latex selected from:
i) a latex having an acid number less than 30;
ii) a latex having an average particle size of from about 20 to about 100 nanometers, and a surfactant contribution from the latex of less than about 20% (w/w) based on the weight of the latex;
iii) a latex having a glass transition temperature of from about 25 to about 65° C., wherein the surface sizing composition further comprises an alkenylsuccinic anhydride; or
iv) a latex, wherein the surface sizing composition further comprises an alkenylsuccinic anhydride and wherein (A) the alkenylsuccinic anhydride and latex are mixed in a low shear process, (B) the alkenylsuccinic anhydride and latex are mixed in an in-line mixer, or (C) the surfactant contribution from the latex in the surface size composition is less than 20% (w/w) based upon the weight of the latex.

30) A paper coated by a surface sizing composition comprising:
a) starch; and
b) a latex selected from:
i) a latex having an acid number less than 30;
ii) a latex having an average particle size of from about 20 to about 100 nanometers, and a surfactant contribution from the latex of less than about 20% (w/w) based on the weight of the latex;
iii) a latex having a glass transition temperature of from about 25 to about 65° C., wherein the surface sizing composition further comprises an alkenylsuccinic anhydride; or
iv) a latex, wherein the surface sizing composition further comprises an alkenylsuccinic anhydride and wherein (A) the alkenylsuccinic anhydride and latex are mixed in a low shear process, (B) the alkenylsuccinic anhydride and latex are mixed in an in-line mixer, or (C) the surfactant contribution from the latex in the surface size composition is less than 20% (w/w) based upon the weight of the latex.
